(19) United States
(12) Patent Application Publication
(10) Pub. No.: US 2005/0281642 A1
(43) Pub. Date: Dec. 22, 2005

(54) Support device

(76) Inventors: Graham Green, Leeds (GB); Bob Hood, Leeds (GB)

Correspondence Address: HEAD, JOHNSON & KACHIGIAN, 228 W 17TH PLACE, TULSA, OK, 74119, US

(21) Appl. No.: 11/123,293

(22) Filed: May 6, 2005

(30) Foreign Application Priority Data
May 10, 2004 (EP) 04252697.0

(51) Int. Cl. B65G 1/00

(52) U.S. Cl. 414/332

(57) ABSTRACT

A support device (2) is provided for supporting an article in a required position following inversion of the article. The device includes outer fame means defining an interior cavity into which at least a part of the article is located in use, and inner support means associated with the frame means for supporting the article located therein in a required position. The support means are capable of undergoing rotational movement, thereby allowing rotation of said article to the inverted position.

This invention relates to a support device, and particularly but not necessarily exclusively to a support device for supporting an article and allowing the article to be moved to a required position.

Although the following description refers almost exclusively to a support device for use in supporting a refuge or waste bin, it will be appreciated by persons skilled in the art that the present invention can be used for support any object, to allow one or more sides of the object to be accessed or become more accessible to a user.

Large amount of waste rubbish are produced by companies and individuals each day and such waste and rubbish is normally disposed of in waste bins, some of which can be large and/or leavy, even when empty. Many of these bins are provided with one or more wheels or rollers, brakes and/or the like on a base thereof to increase the ease with which the bins can be transported between required locations and/or to maintain the bins in a required position in use. It is often the case that the wheels, brakes, casters bearings and/or one or more components connected thereto need regular replacement and/or repair. Conventionally, such replacement and/or repair requires a user to life the bin and rotate the same manually to upturn the bin to allow the user to gain access to the base of the bin. However, this typically requires more than one user, particularly in the case of large industrial size waste bins and often results in injuries to a user due to the weight and size of the bins. In addition, the bins are frequently damaged as a result of impacting with the floor during inversion.

A number of devices are known which allow waste bins to be emptied by inverting the bin, although none of these devices are designed for use in repairing bins. These known devices typically use pivotable mechanisms to invert the bin, such as the mechanisms disclosed in FR2765199 in which a mobile washing machine is provided. The bin is fastened to a support at the rear of a waste disposal vehicle and the support moves on a rail to allow the bin to be lifted, titled and inverted. A further example is disclosed in NL1006840 wherein a bine is moved between three conveyors to move the bin from an upright position to an inverted position. A yet further example is disclosed in DE20102069 wherein a support frame is provided which has a lever and a clamp for gripping the handle of a bin, the lever rotates, thereby rotating the bin through 180 degrees. A problem with the abovedescribed mechanisms is that they are generally for use with small domestic waste bins and are not designed for use with larger industrial sized bins. In addition, they require powered means, hereby making the device expensive to manufacture and use and/or still require the user to input a significant amount of energy to use the same.

It is therefore an aim of the present invention to provide a support device which is inexpensive to manufacture and operate, allows the user to expend the minimum amount of energy to use the same and reduces the risk of injury to the user.

It is a further aim of the present invention to provide a support device which allows easy access to one or more portions of an article located with the support device.

According to a first aspect of the present invention there is provided a support device for supporting an article, said device including frame means defining an interior cavity into which at least a part of said article is located in use, and support means associated with the frame means for supporting said article located therein in a required position, and wherein at least the support means are capable of undergoing rotational movement, thereby allowing rotation of said article.

In use, the article is located in or on the support means and the support means can be rotated to allow the article to be rotated to a required angle, typically between 0 and 360 degrees. This allows one or more sides of the article to become accessible or more easily accessible to a user, so as for example, to allow repair and/or replacement of one or more parts associated with the article. In a preferred example, the article is inverted, typically through 180 degrees.

Preferably the support means are connected to or arranged relative to the frame means in such a manner that the support means rotates on rotation of the frame means, thereby allowing the at least one article to be rotated.

The frame means is typically located on a base or suitable surface and the frame means is capable of undergoing rotation relative to said base or surface.

In one embodiment the support means rotates relative to the frame means. For example, the frame means can define one or more channels in which the support means are rotatably located.

Preferably movement means are provided for allowing rotational movement of the frame means. These movement means can be powered means but in a preferred embodiment the movement means are provided for allowing manual rotation of the frame means.

In one embodiment the movement means includes one or more wheel members on or between which the frame means is movably located. One or more of the wheel members can be provided with channels on an outer surface thereof and one or more portions of the frame means can be movably located or rotatably mounted in said channels.

In one embodiment one or more panels can be provided between one or more portions of the frame means if required. In this embodiment, the panels are arranged so as not to prevent or hinder access of a user to one or more surfaces of an article located therein. Preferably the frame means includes an outer frame and the support means is in the form of or includes an inner frame substantially or partially located within the outer frame.

The inner frame means typically defines an inner cavity which is of dimensions slightly larger than the dimensions of the article to allow the article to be located within the inner frame. As such, the inner frame means prevents, at least in part, the article from falling out of the support device.

Preferably the inner frame means or support means includes one or more rails onto which the article, typically the base of the article, is located. When the article is positioned on said rails, the article is typically substantially enclosed ro surrounded by said inner frame means or support means.

Movement means can be provided in association with the inner frame to increase the ease with the article can be located therein. For example, the movement means can include any or any combination of one or more wheels, rollers, ball bearings and/or the like. The movement means can be provided on said rails or one or more other parts of the inner frame.

In one embodiment at least the inner frame means or support means are arranged so as to provide an inlet and/or an outlet to allow an article to be located within the inner frame means. The same or further inlet and/or outlet means can be defined in the outer frame means.

Preferably securing means are provided with the inner and/or outer frame means to prevent the article from moving out of the inlet and/or outlet by accident. The securing means can be in the form of an engagement mechanism, one or more barrier arms, bolts and/or the like. In a preferred embodiment the inner frame means forms a cage which surrounds the article in use.

Preferably the frame means includes at least one substantially annular member, and preferably at least two substantially parallel annular members located a spaced distance apart. One or more rod members can be provided between the annular members to provide strength and rigidity to the support device. In addition, the rod members and/or annular members can be gripped by a user to rotate the frame means. The rod members are typically substantially horizontal.

The article is typically passed through at least one of the annular members in use and, further preferably the article is located substantially between said annular members in use.

The support means and/or frame means typically rotates about a substantially horizontal axis. Further preferably said means rotates about an axis substantially longitudinal of the device and/or the article located in the device.

Preferably the outer frame means is rotatably mounted on the movement means.

Preferably counterbalancing means are provided in association with the frame means and/or support means, thereby increasing the ease with which a user can rotate the frame means, particularly when a relatively heavy article is located therewith. In one embodiment two or more articles can be located with the support device at the same time if required.

The article can be of any size and/or shape and in a preferred embodiment the article is in the form of a waste disposal receptacle or bin.

Preferably one or more ramps are provided adjacent the inlet and/or outlet means via which the article can be moved onto the support device and be removed from the support device.

In use, the support device is typically provided at a first out of the use position, a base of the inner frame is provided adjacent the base of the support device, thereby allowing an article to be located therewith. Once the article is secured within the inner frame, the outer frame means can be rotated, thereby allowing the article to be rotated to a required angle.

According to a second aspect of the present invention there is provided a method of using a support device, said device including frame means defining an interior cavity therebetween and support means associated with said frame means, said method including the steps of location at least a part of an article in said interior cavity of said frame means and supporting the article in a required position therein using said support means, said method further including the step of rotating at least said support means to allow rotation of said at least one article.

According to a further aspect of the present invention there is provided a waste disposal receptacle support device.

The present invention has the advantage that a large number of articles can be used in the device over any given time period, thereby increasing the efficiency with which the articles can be worked on and reducing the risk of injury to a user. The device requires no special training for use, is inexpensive to manufacture and operate and is easily transportable. In addition, the device can be operated by a single user, thereby reducing the manpower required to use the invention.

Since the article is secured in the inverted or angled position using the support device, higher standards of servicing and repair can be performed by the user.

Embodiments of the present invention will now be described with reference to the accompanying figures, wherein:

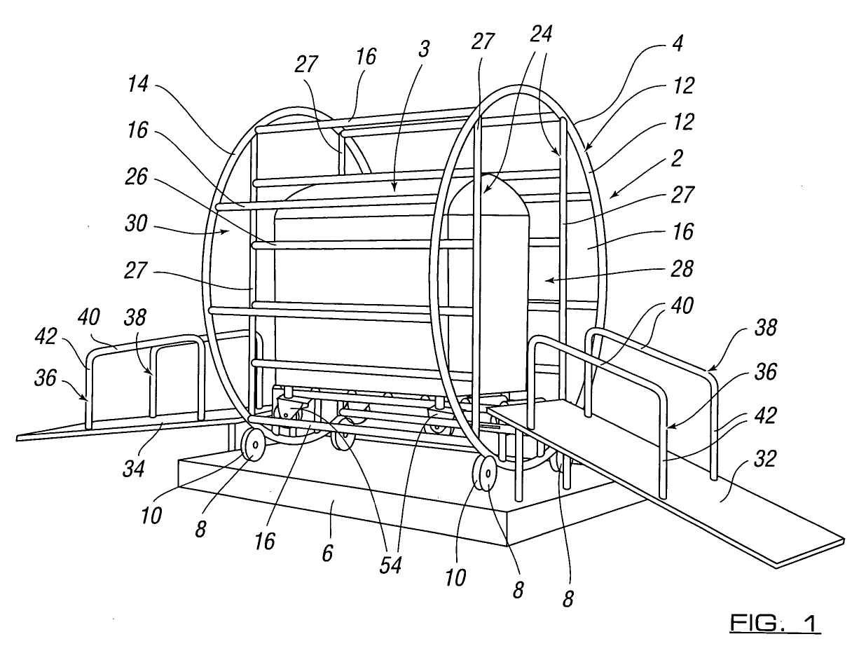

FIG. 1 is a perspective view of a support device for a bin in a first out of use position with a bin located therewith;

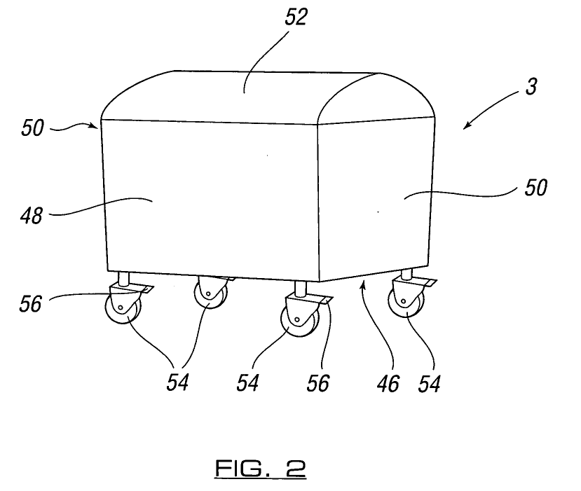

FIG. 2 is a perspective view of an example of the type of bin that can be located with the support device.

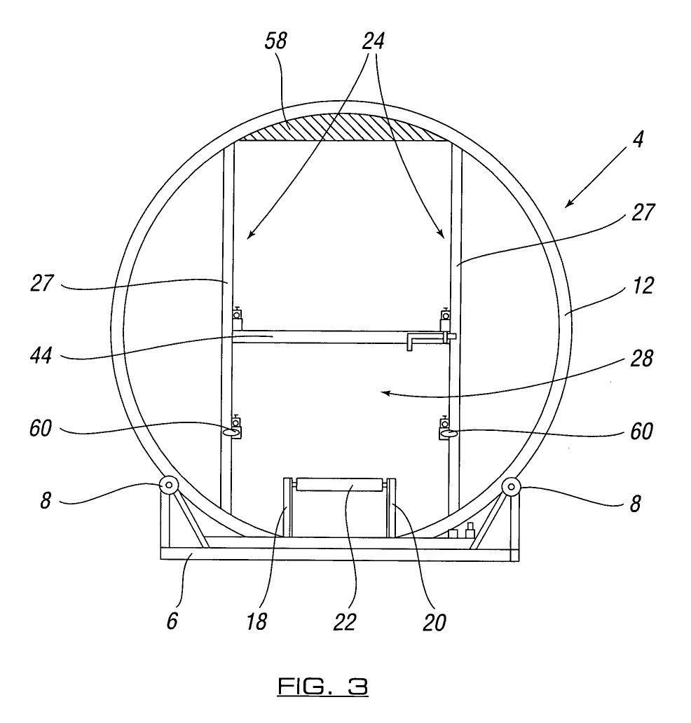

FIG. 3 is a simplified end view of the support device in one embodiment in an out of use position.

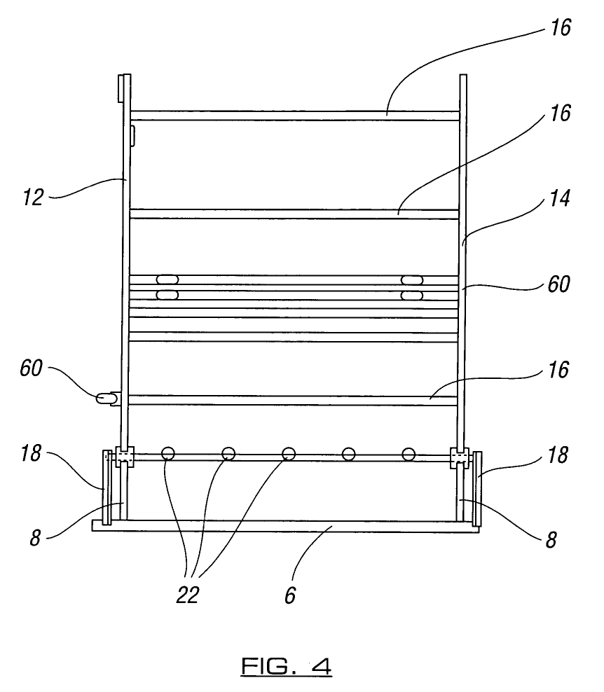

FIG. 4 is a simplified side view of the support device in an out of use position in one embodiment;

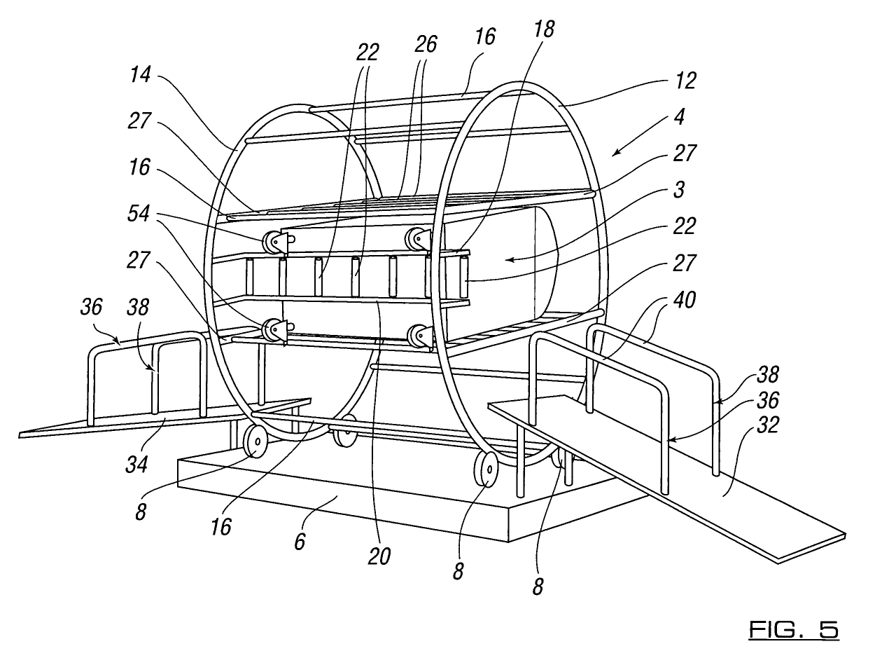

FIG. 5 is a perspective view of the support device in FIG. 1 following rotation through 90 degrees; and

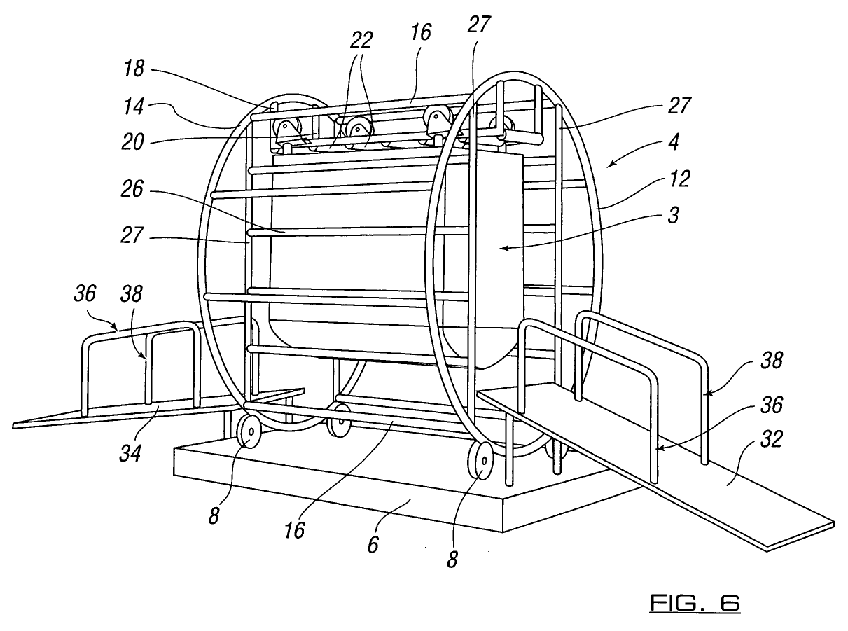

FIG. 6 is a perspective view of the support device in FIG. 1 following rotation through 180 degrees;

Referring to the figures, there is illustrated a support device 2 for supporting a bin 3 therewith and allowing rotation of the bin to a required position with little exertion required on the part of a user.

The support device 2 includes an outer frame 4 which is rotatably mounted on a base 6. Movement means in the form of a plurality of rotatable wheels 8 are provided on the base at spaced apart intervals. Each wheel engages with a portion of outer frame 4. Two wheels 8 engage one end of the outer frame and two wheels 8 engage the opposite end of the outer frame. The rotatable wheels 8 have a channel 10 defined along an outer edge thereof in which the frame locates.

More specifically, the outer frame 4 includes two annular members 12, 14 located at opposite ends of the device which are separated by a plurality of elongated rod members 16. The rod members 16 typically provide strength and rigidity to the frame 4 and are arranged substantially horizontally in this example. However, the rod members can be angled if required. Two lower portions of each of the annular members 12, 14 are located in the channels 10 of wheels 8 and the annular members are freely rotatable therein.

The outer frame 4 defines an interior cavity into which the bin 3 is located is use. Although the bin 3 is fully enclosed in the interior cavity in this example, it will be appreciated that only a part of said bin 3 needs to be enclosed, wholly or partially, within said cavity. For example, one or both ends of the bin could protrude from the outer frame. Alternatively, or in addition, the members 12, 14 may be partially annular, arc shaped and/or the like.

Support means in the form of an inner frame 24 are provided within outer frame 4. The inner frame 24 includes two rails 18, 20 provided at the base of the device when in an out of use position. The rails 18, 20 are parallel and provided a pre-determined spaced distance apart. A plurality of rollers or wheel members 22 are provided transverse to and between rails 18, 20. These rollers 22 increase the ease with which an article can be moved onto and off the support device in use.

In the embodiment described, the support device is of such a shape and size so as to accommodate an industrial size refuse bin 3. More particularly, inner frame 24 is of slightly larger dimensions than the outer dimensions of bin 3 to hold the bin in place during rotation of the device. For example, in one embodiment the inner frame has a tolerance of 4-5 mm with respect to the bin size. The inner frame 24 further includes two parallel spaced apart members 27 which form chords on each of annular members 12, 14. A plurality of rod members 26 are provided between members 27 on opposing annular members 12, 14.

It will be appreciated that in one embodiment the inner frame means can be rotatable within said outer frame means or relative thereto if required.

The inner frame 24, and particularly the members 27 are arranged so as to provide an inlet 28 and an outlet 30 to allow a bin to be moved into the device and removed from the device respectively, although it will be appreciated that the bin could be moved into the device and removed from the device via the same entrance. Ramps 32, 34 are provided adjacent either or both of inlet 28 and outlet 30 and extend away from device 2, thereby increasing the ease with which a bin can be moved into and from the device. A pair of parallel support rails 36, 38 are mounted on either side of ramps 32, 34 respectively to prevent the bin from falling off the ramps during movement. The support rails 36, 38 typically include a substantially horizontal rail member 40 which is positioned at such a height so as to be between the base and top of the bin in use. Vertical rail members maintain rail members 40 in position.

If required, securing means in the form of a barrier arm 44 can be provided adjacent inlet 28 and/or outlet 30 to prevent the bin from rolling out of the device 2 during rotation. The barrier arm 44 can be detachably attached to members 27 or can be pivotally mounted on one side of the member 27.

The base 6 of the device can be provided with movement means in the form of wheels or rollers to allow the same to be easily transported. Alternatively, the base 6 can be provided on or forms part of a vehicle or some other means of transport, such as a trailer to allow the device to be moved to one or more required locations.

The industrial bins 3 which are shown for use in the illustrated embodiment with the support device typically include a base 46, side walls 48, end walls 50 and a lid 52. Wheels 54 are provided on each corner of the base of the bin to allow the bin to be transported. Brakes 56 are provided in association with the wheels 54 to allow the bin to be secured tin a required position in use. When the brakes, wheels, bearings and/or the like require replacement, the bin 3 has to be inverted through 90-180 degrees to allow a user to access the base.

In us of the support device 2, the device is initially in a first out-of-use position, as shown in FIG. 1. A bin is wheeled up ramp 32 and through inlet 28 defined by inner frame 24. The ramp 32 is positioned relative to the rails 18, 20, such that wheels/rollers 22 provided between rails 18, 20 engage the base 46 of bin 3, thereby increasing the case with which the bin can be moved within inner frame. The inner frame acts as a cradle for the bin and maintains the bin in position during use of device 2. Once the bin is in position, barrier arm 44 provided at either end of the inner frame 24 can be secured in place to prevent the bin from rolling out of inlet 28 or outlet 30.

A user typically grips a portion of annular member 12 or 14 and rotates the same via wheels 8 to a required angle. FIG. 5 illustrates an intermediate position with the bin located at 90 degrees to its starting position. FIG. 6 illustrates an inverted position with the bin located at 180 degrees to its starting position. It will be understood that the user can rotate the bin through any required angle, typically between 0 and 360 degrees. Stop means, such as braking mechanisms (not shown), can be provided on the frame means and/or support means, such as wheels 8 to lock the device in a particular position, thereby maintaining the bin 3 in a required position. The braking mechanism in one embodiment is in the form of a spring biased bolt mechanism. A counter balance mechanism, such as for example in the form of a weighted segment 58 provided at the top of annular members 12, 14 when in an out of use position, can be provided to increase the ease with which a user can rotate the device, thereby reducing the energy required to use the device and reducing the risk of injury to a user. The support device 2 can be rotated manually or powered means can be used, such as via a motor and gearing system.

Ramps 32, 34 are typically free standing but can be attached to base 6 is required.

Further roller or wheel members can be provided to increase the case with which the bin can be moved onto and off the device 2. For example, rollers 60 can be provided on members 27 and/or rod members 26.

It will be appreciated that the support device of the present invention can be of any size and/or shape suitable for securing any required bin size or any other sized article.

The device can be made from any suitable material, such as wood, plastic and/or metal. The inner and outer frames can be have any number of required rod members and/or panels associated therewith to provide support bu the rod members and/or panels are typically located so as to allow easy user access to all portions of the bin in use.

1. A support device for supporting an article, said device comprising:
frame means defining an interior cavity into which at least a part of said article is located in use, and
support means associated with the frame means for supporting said article located therein in a required position, and wherein at least the support means are capable of undergoing rotational movement, thereby allowing rotation of said article.

2. A device according to claim 1 wherein said support means are arranged relative to said frame means in such a manner that said support means rotates on rotation of said frame means.

3. A device according to claim 1 wherein said support means rotates relative to said frame means.

4. A device according to claim 2 wherein movement means are provided for allowing rotational movement of said frame means and/or support means.

5. A device according to claim 4 wherein said movement means include powered means.

6. A device according to claim 4 wherein said movement means is manually powered.

7. A device according to claim 4 wherein said movement means includes one or more wheel members mounted on a base said frame means being movably located on or between said wheel members.

8. A device according to claim 4 wherein said frame means defines one or more channels therein and said support means is rotatably mounted in said channels.

9. A device according to claim 7 wherein said one or more of said wheel members include one or more channels on an outer surface thereof and at least a portion of said frame means is movably located in said channels.

10. A device according to claim 1 wherein one or more panel members are provided between one or more portions of said frame means.

11. A device according to claim 1 wherein said frame means forms an outer frame and said support means is in the form of an inner frame located substantially or partially within the outer frame.

12. A device according to claim 11 wherein said inner frame defines a cavity therein having dimensions slightly smaller than an article which is to be located therein in use.

13. A device according to claim 1 wherein said support means includes one or more rails onto which a base of the article is located in use.

14. A device according to claim 1 wherein securing means are provided to allow the article to be secured to or within said support means and/or said frame means.

15. A device according to claim 14 wherein said securing means includes one or more barrier arms or bolts.

16. A device according to claim 1 wherein one or more inlets and/or outlets are defined in said frame means and/or support means for allowing the article to be located therein in use.

17. A device according to claim 16 wherein one or more ramp members are provided adjacent said inlets and/or said outlets.

18. A device according to claim 1 wherein said frame means includes at least two substantially parallel annular members located a spaced distance apart.

19. A device according to claim 18 wherein one or more rod members are provided between said at least two annular members.

20. A device according to claim 1 wherein said support means and/or frame means rotates about a substantially horizontal axis.

21. A device according to claim 1 wherein said support means and/or frame means rotate about an axis substantially longitudinal of said support device and/or the article located in said device in use.

22. A device according to claim 1 wherein counterbalancing means are provided in association with said frame means and/or support means.

23. A device according to claim 1 wherein said article is a waste disposal receptacle or bin.

24. A device according to claim 1 wherein said frame means are provided on a base having movement means thereon.

25. A device according to claim 1 wherein stop means are provided to prevent rotation of said support means and/or frame means when required.

26. A method of using a support device having frame means defining an interior cavity therebetween and support means said method comprising the steps of:
locating at least a part of an article in said interior cavity of said frame means;
supporting the article in a required position therein using said support means, and
rotating at least said support means to allow rotation of said at least one article.

27. A device according to claim 3 wherein movement means are provided for allowing rotational movement of said frame means and/or support means.
